(19) United States
(12) Patent Application Publication
(10) Pub. No.: US 2006/0016682 A1
(43) Pub. Date: Jan. 26, 2006

(54) Solar seawater desalting apparatus

(76) Inventor: Bo Wen Lin, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/895,357

(22) Filed: Jul. 21, 2004

(51) Int. Cl. C02F 1/04; B01D 3/00

(52) U.S. Cl. 202/234; 202/267.1; 203/10; 203/DIG. 1; 203/86; 159/903; 159/28.6; 159/DIG. 15

(57) ABSTRACT

A solar seawater desalting apparatus includes a solar module, an insulating plate mounted below the solar module, a conductive plate, a condensing room below the insulating plate and communicated with the seawater channel, and a thermal plate mounted in the insulating plate. The conductive plate is mounted to an upper side of the insulating plate for heating seawater flowing through a seawater channel between the insulating plate and the solar module. A top of the condensing room is delimited by a cooling plate. A collecting chamber is provided in the condensing room and located below the cooling plate. The thermal plate includes a high temperature area in contact with the conductive plate and a low temperature area in contact with the cooling plate. Water in the heated seawater vaporizes in the condensing room and condenses at the cooling plate, and the condensed water is collected in the collecting chamber.

### BACKGROUND OF THE INVENTION

1. Field of the Invention

The present invention relates to a solar seawater desalting apparatus. In particular, the present invention relates to a solar seawater desalting apparatus using solar energy to obtain freshwater from seawater.

2. Description of the Related Art

Desalting technique for obtaining drinkable water from seawater has become mature after years of research and development. However, the cost is still high, as the fuel and/or electricity for desalting are not cheap plus loss during energy conversion. Solar energy is another option at a lower cost. A photoelectric module generates electricity for removing salt from seawater. However, temperature of the photoelectric module often exceeds 50° C., resulting in malfunctions of the photoelectric module. Cooling of the photoelectric module requires additional energy.

### SUMMARY OF THE INVENTION

In accordance with an aspect of the invention, a solar seawater desalting apparatus comprises a solar module, an insulating plate mounted below the solar module, defining a seawater channel between the solar module and the insulating plate, a conductive plate, a condensing room below the insulating plate and communicated with the seawater channel, and a thermal plate mounted in the insulating plate.

The conductive plate is mounted to an upper side of the insulating plate for heating seawater flowing through the seawater channel. The conductive plate defines a sealed compartment containing a superconductive liquid.

A top of the condensing room is delimited by a cooling plate. The cooling plate defines a sealed compartment containing a superconductive liquid. A collecting chamber is provided in the condensing room and located below the cooling plate. The thermal plate includes a first side in contact with the conductive plate and a second side in contact with the cooling plate. When the thermal plate is supplied with electricity, the first side of the thermal plate becomes a high temperature area and the second side of the thermal plate becomes a low temperature area.

Seawater is guided into the condensing room via the seawater channel and heated by the conductive plate. Water in the heated seawater vaporizes in the condensing room and condenses at the cooling plate, with the condensed water being collected in the collecting chamber.

In an embodiment of the invention, the cooling plate is mounted to an underside of the insulating plate. The solar module includes a solar energy collecting plate and a photoelectric plate. The solar energy collecting plate and the photoelectric plate of the solar module are arranged to form an inclined plate. The conductive plate is flush with the upper side of the insulating plate and in parallel with the inclined plate.

Preferably, the conductive plate is made of copper and the cooling plate is made of titanium.

Other objects, advantages, and novel features of the invention will become more apparent from the following detailed description when taken in conjunction with the accompanying drawings.

### BRIEF DESCRIPTION OF THE DRAWINGS

FIG. 1 is a sectional view of a solar seawater desalting apparatus in accordance with the present invention.

FIG. 2 is an exploded perspective view of a portion of the solar seawater desalting apparatus in accordance with the present invention.

FIG. 3 is an enlarged sectional view of the portion of the solar seawater desalting apparatus in accordance with the present invention.

FIG. 4 is a sectional view similar to FIG. 1, illustrating operation of the solar seawater desalting apparatus in accordance with the present invention.

### DETAILED DESCRIPTION OF THE PREFERRED EMBODIMENT

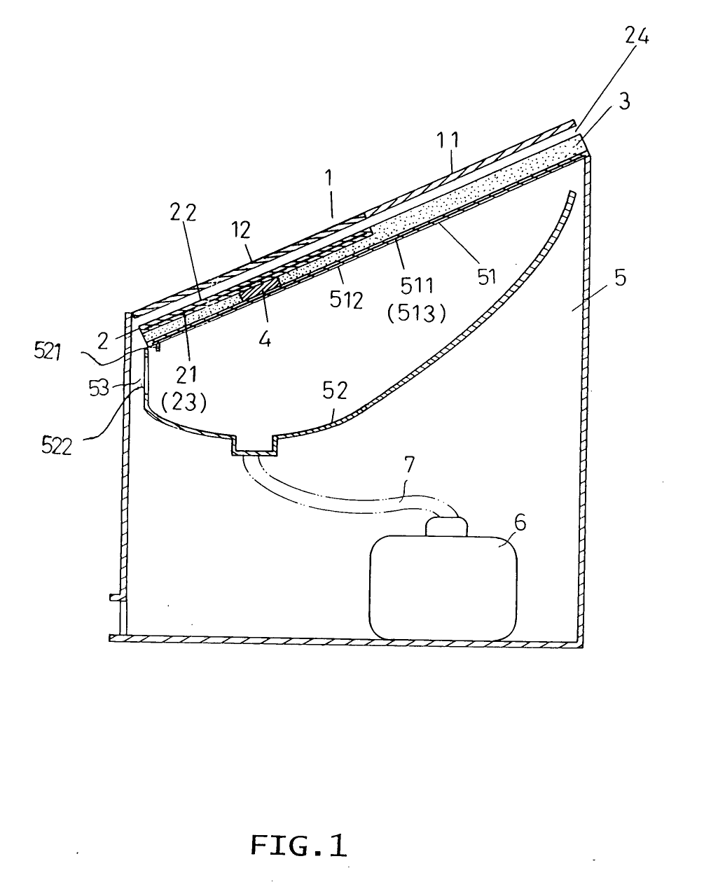

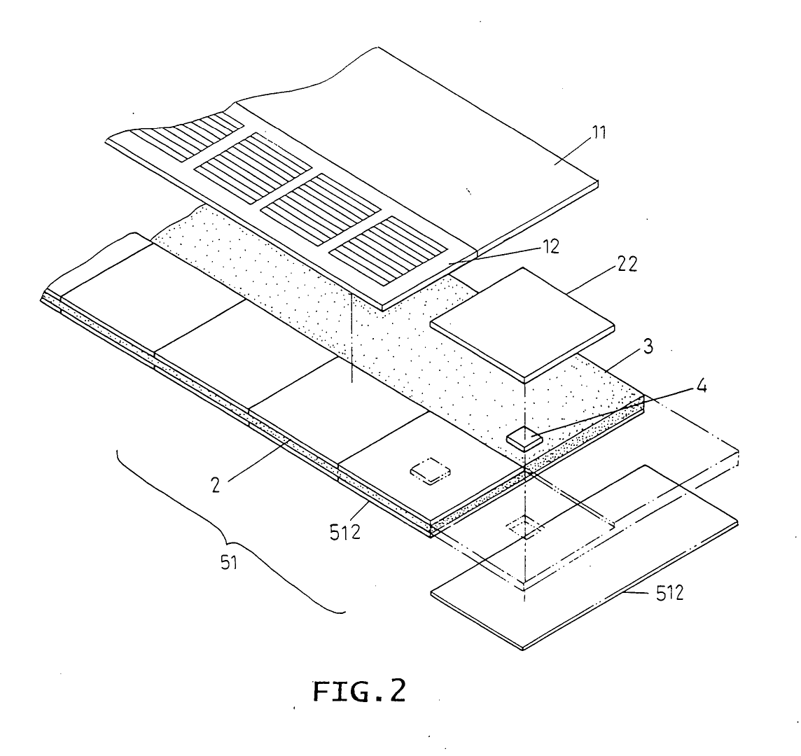

Referring to FIGS. 1 through 3, a solar seawater desalting apparatus in accordance with the present invention comprises a solar module 1, a conductive plate 2, a heat-insulating plate 3, a thermal plate 4, and a condensing room 5. The solar module 1 comprises a solar energy collecting plate 12 and a photoelectric plate 11 for transforming solar energy into electricity. Preferably, the solar energy collecting plate 12 and the photoelectric plate 11 are contiguous to each other to form an inclined plate.

The conductive plate 2 is a plate 22 defining a sealed compartment 21 containing a superconductive liquid 23 with excellent thermal conductivity. The conductive plate 2 is mounted to a portion of an upper side of the heat-insulating plate 3 and preferably flush with the upper side of the heat-insulating plate 3. Thus, a seawater channel 24 is defined between the solar module 1 and the heat-insulating plate 3/conductive plate 2, as shown in FIG. 1. Preferably, the conductive plate 2 is made of copper.

The condensing room 5 is defined below the heat-insulating plate 3 and communicated with the seawater channel 24 via an opening 53. Preferably, a top of the condensing room 5 is delimited by a cooling plate 51 that is fixed to an underside of the heat-insulating plate 3. The cooling plate 51 is a plate 512 made of titanium and defines a sealed compartment 511 containing a superconductive liquid 513 with excellent thermal conductivity. A collecting chamber 52 is provided in the condensing room 5 and located below the cooling plate 51 for collecting condensed freshwater that can be drained to and thus collected in a container 6 via a pipe 7.

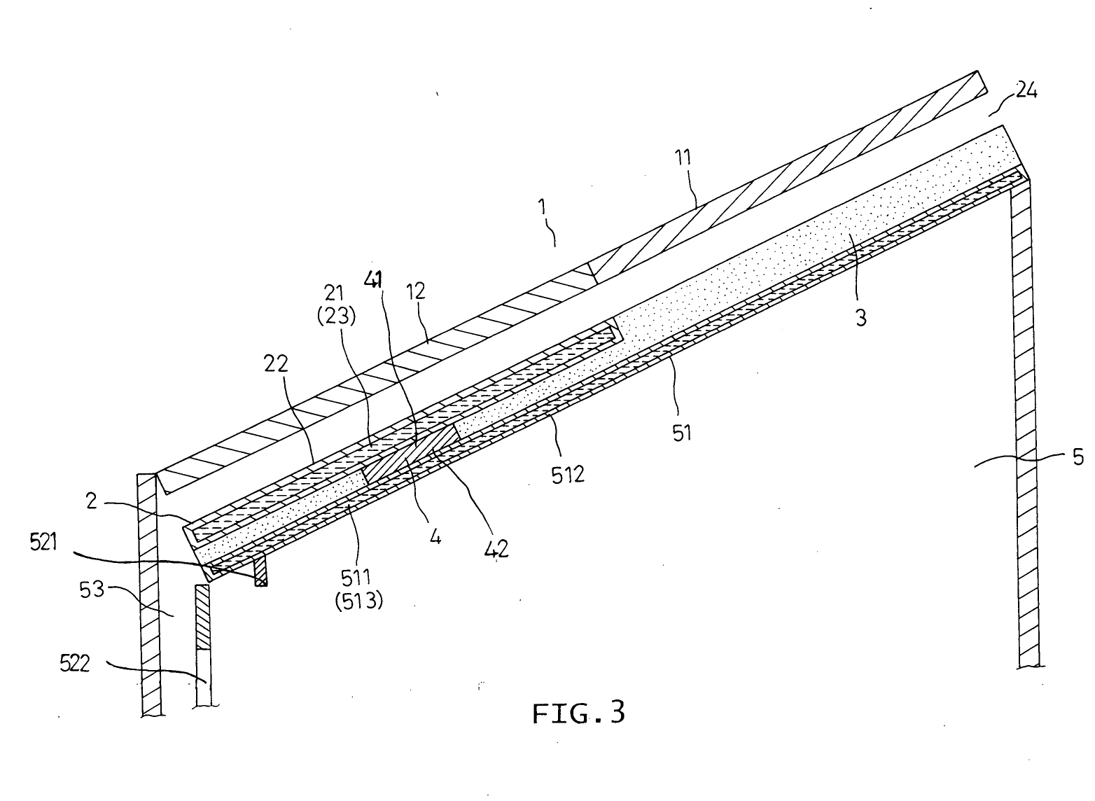

As illustrated in FIG. 3, the thermal plate 4 is embedded in the heat-insulating plate 3, with a first side of the thermal plate 4 being in contact with the conductive plate 2 and with a second side of the thermal plate 4 being in contact with the cooling plate 51. The thermal plate 4 is so configured that the first side of the thermal plate 4 becomes a high temperature zone 41 and the second side of the thermal plate 4 becomes a low temperature zone 42 when the thermal plate 4 is supplied with electricity from, e.g., the solar module 1. Such a thermal plate 4 is conventional and therefore not described in detail. Thus, heat is transferred from the first side of the thermal plate 4 to the conductive plate 2 for heating seawater, and the cooling plate 51 is cooled by the second side of the thermal plate 4 for condensing water.

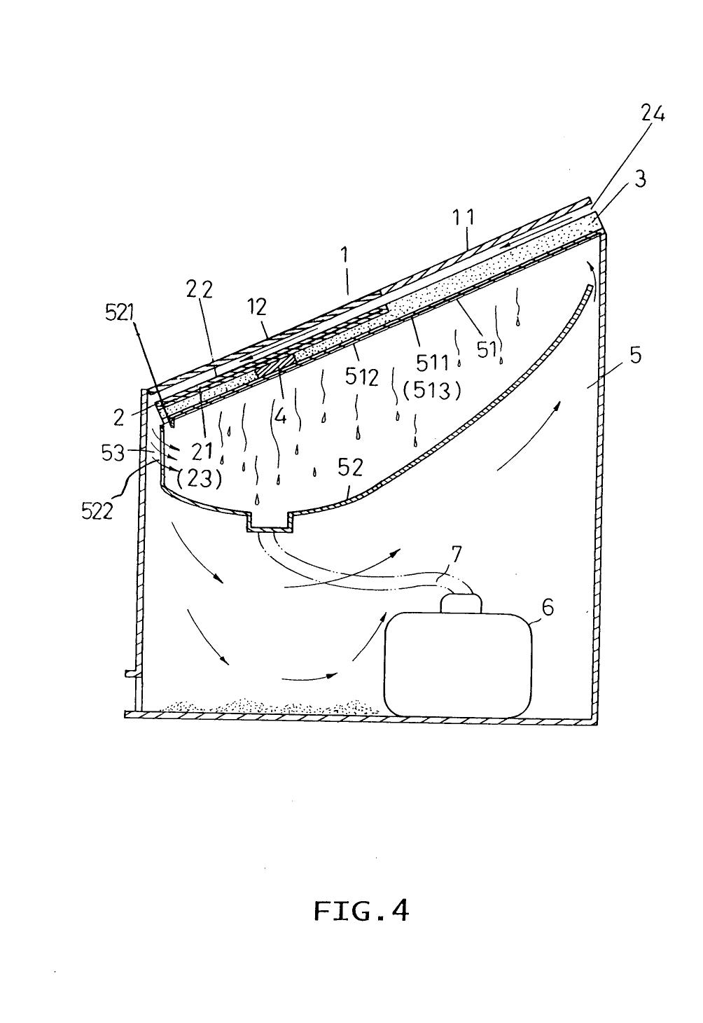

Referring to FIG. 4, sweater is guided into the seawater channel 24 and then into the condensing room 5 via the opening 53. The seawater passing through the seawater channel 24 is heated to approximately 70° C. by the conductive plate 2. Thus, the seawater entering the condensing room 5 is at approximately 70° C. The water in the heated seawater vaporizes in the condensing room 5 and the water vapor condenses at the underside of the cooling plate 512 that is also inclined. A sidewall delimiting the collecting chamber 52 includes an opening 522 to allow water vapor to enter the collecting chamber 52. A stop plate 521 is provided on a lower end of the inclined cooling plate 512 to stop a portion of water vapor. The condensed water is collected in the collecting chamber 52. The solid remain after vaporization of water in the seawater can be collected and further processed for other purposes.

The cost for desalting seawater by the solar seawater desalting apparatus in accordance with the present invention is relatively low. The seawater flowing through the seawater channel 24 cools the solar module 1 to prevent overheating the solar module 1. The thermal plate 4 and the superconductive liquids 23 and 513 allow rapid heat transfer. The seawater can be effectively desalted to obtain freshwater. The remaining seawater can be discharged to another station for further processing to obtain salts.

Although specific embodiments have been illustrated and described, numerous modifications and variations are still possible without departing from the essence of the invention. The scope of the invention is limited by the accompanying claims.

What is claimed is:

1. A solar seawater desalting apparatus comprising:
a solar module including a solar energy collecting plate and a photoelectric plate;
an insulating plate mounted below the solar module, defining a seawater channel between the solar module and the insulating plate, the insulating plate including an upper side and an underside;
a conductive plate mounted to the upper side of the insulating plate for heating seawater flowing through the seawater channel, the conductive plate defining a sealed compartment containing a superconductive liquid;
a condensing room below the insulating plate and communicated with the seawater channel, a top of the condensing room being delimited by a cooling plate, the cooling plate defining a sealed compartment containing a superconductive liquid, a collecting chamber being provided in the condensing room and located below the cooling plate; and
a thermal plate mounted in the insulating plate and including a first side in contact with the conductive plate and a second side in contact with the cooling plate, the thermal plate being supplied with electricity such that the first side of the thermal plate becomes a high temperature area and the second side of the thermal plate becomes a low temperature area;
seawater being guided into the condensing room via the seawater channel and heated by the conductive plate, water in the heated seawater vaporizing in the condensing room and condensing at the cooling plate, with the condensed water being collected in the collecting chamber.

2. The solar seawater desalting apparatus as claimed in claim 1, with the cooling plate being mounted to the underside of the insulating plate.

3. The solar seawater desalting apparatus as claimed in claim 1, with the solar energy collecting plate and the photoelectric plate of the solar module being arranged to form an inclined plate.

4. The solar seawater desalting apparatus as claimed in claim 1, with the conductive plate being made of copper.

5. The solar seawater desalting apparatus as claimed in claim 1, with the cooling plate being made of titanium.

6. The solar seawater desalting apparatus as claimed in claim 3, with the conductive plate being flush with the upper side of the insulating plate and in parallel with the inclined plate.
